(19) United States
(12) Patent Application Publication
(10) Pub. No.: US 2026/0085807 A1
(43) Pub. Date: Mar. 26, 2026

(54) Injection-Molded Component and Method for Manufacturing an Injection-Molded Component

(71) Applicant: Bayerische Motoren Werke Aktiengesellschaft, Muenchen (DE)

(72) Inventors: Andreas KNOEDLER-BUNTE, Muenchen (DE); Franz TROFFER, Grosskoellnbach (DE); Bernd VEIHELMANN, Landshut (DE)

(21) Appl. No.: 19/112,634

(22) PCT Filed: Aug. 7, 2023
(86) PCT No.: PCT/EP2023/071795

§ 371 Date: Mar. 18, 2025

(30) Foreign Application Priority Data
Sep. 19, 2022 (DE) 10 2022 123 933.0

(51) Int. Cl. F21S 43/50; B29C 45/14; B29L 31/30

(52) U.S. Cl. CPC F21S 43/50; B29C 45/14065; B29C 45/1418; B29C 45/14688; B29C 45/14811; B29C 2045/14147; B29C 2045/14532; B29C 2045/14696; B29K 2995/0026; B29L 2031/3005

(57) ABSTRACT

An injection-molded component for a motor vehicle, including a first film insert having a first printed area, a second film insert having a second printed area, and a transparent plastic layer disposed between the first film insert and the second film insert. The first printed area is configured to act as a cover for partially covering the second printed area.

### BACKGROUND AND SUMMARY

The present disclosure relates to an injection-molded component, to a method/process, and to a motor vehicle, according to the independent claim(s).

It is nowadays customary to configure individual parts of a motor vehicle in the form of an injection-molded component. For example, decorative panels are frequently injection-molded since this enables rapid and efficient manufacturing in the correct shape. The injection-molded components not only have to meet crash safety standards but often also serve to fulfill further functions for motor vehicle manufacturers. For example, it is customary that the decorative panels are produced either with or without sensor functionality. For this purpose, transparent and straight surfaces have to be provided. At the same time, the decorative panels should be visually apparent and noticeable, in order to increase visibility and hence safety. At present, visibility and visual appeal are increased in that the decorative panels are created by geometry, for example via 3D embossments, and/or coloring, for example with a single or multicolor appearance, or metallic effects. This can be established either via paint/PVD processes or via printed foil inserts.

By foils and paints, it is possible to implement only 2D designs. Although it is possible to introduce optical effects, these effects remain static at variable viewing angles, meaning that visibility is not increased thereby. It is also possible to introduce true 3D embossments, but sensor suitability, for example for RADAR, is lost. This 3D effect is also frequently no longer apparent in a warm appearance, i.e. with lighting, since these embossments leave only a 2D impression under light.

It is therefore an object of the present disclosure to at least partly remedy the above-described disadvantages in injection-molded components for a motor vehicle. In particular, it is an object of the present disclosure to provide an injection-molded component for a motor vehicle and a process for producing an injection-molded component for a motor vehicle which increase visibility and hence safety in a simple and inexpensive manner.

The above object is achieved by an injection-molded component, by a method/process, and by a motor vehicle, according to the independent claim(s). Further features and details of the present disclosure will be apparent from the dependent claims, the description and the drawings. Features and details that are described in association with the injection-molded component of the present disclosure are of course also applicable in association with the process of the present disclosure and/or in association with the motor vehicle of the present disclosure, and vice versa in each case, such that mutual reference is or may always be made to the individual aspects of the present disclosure with regard to the disclosure.

The present disclosure provides an injection-molded component for a motor vehicle, having a first foil insert having a first print region, a second foil insert having a second print region, and a transparent polymer layer disposed between the first foil insert and the second foil insert, wherein the first print region is configured as a panel for coverage of sections of the second print region.

The print region in the present context means the region of the respective foil insert that has a print. The print is applied by a printing method, preferably screen printing or digital printing, prior to production of the injection-molded component. It is ensured here that the first and second foil inserts have different patterns and/or colors; for example, it is possible to apply a color fade or a mirror effect, in particular a color fade which is apparent to the human eye by virtue of the first print region in spite of the stop effect of the panel.

What is meant by the stop effect of the first foil insert is that the first foil insert is not printed completely by the first print region but has at least one transparent region. The second foil insert is then arranged such that the second print region can be seen through the at least one transparent region of the first foil insert. This means that the unprinted regions of the first foil insert permit a view of the second print region of the second foil insert.

Because of the arrangement of the first and second foil inserts and the polymer layer in between, both a depth effect and a 3D effect are created. This increases visibility of the injection-molded component. The injection-molded component may be a decorative panel for the cooling grille, the tailgate, the C pillar or the B pillar. As a result of increased perception owing to the depth effect and the 3D effect, not only is an optical effect achieved, but also an increase in safety owing to visibility.

Owing to the inventive arrangement of the layers and foil inserts, no embossed parts of complex manufacture are needed to create the optical effects. Moreover, not only are there material and hence cost savings, but the injection-molded component is also manufactured more efficiently and at lower cost.

Simple construction by the foil inserts permits one or more smooth surfaces having high sensor suitability, for example for RADAR.

In the context of the present disclosure, it is conceivable that the polymer layer has a thickness of 3 to 7 mm, preferably 4.5 to 6.5 mm, further preferably 5 to 6 mm.

For the desired depth effect and 3D effect, a particular distance between the print layers is advisable. The distance depends on the desired effect and the desired color fade or pattern. A depth effect can be ensured with a thickness of the polymer layer between 3 and 7 mm.

In the context of the present disclosure, it may be advantageous when the polymer layer is made of polymethylmethacrylate and/or polycarbonate.

These materials enable simple manufacture by injection molding and have sufficient strength for the respective field of use. In addition, the materials have transparency suitable for sensor suitability.

It may be the case in the context of the present disclosure that a light source is provided for coupling of light into the polymer layer, where the light source is configured to run at least partly around the circumference of the injection-molded component.

The light source may be a lamp, for example having LEDs, or a light tube composed of various LEDs. The light source may be disposed on one side or on two opposite sides of the injection-molded component or around the entire circumference of the injection-molded component.

Illumination by a light source amplifies the effects, meaning that the depth effect and/or the 3D effect are/is more apparent and hence more visible. This is particularly advantageous in a dark environment, for example in a tunnel or at night.

It is conceivable in accordance with the present disclosure that the first foil insert has a surface facing away from the polymer layer, where the surface has a coating.

This surface may be exposed to the environment and hence environmental influences. The coating thus protects the injection-molded component from outside influences and hence increases the service life of the injection-molded component.

It is also conceivable that the second foil insert has a third foil insert or an optical surface, especially a display, on a surface facing away from the polymer layer.

A third foil insert enables a more extreme depth effect and has a positive effect on the visual appearance. It would be conceivable that a display is bonded behind the second foil insert. This may be matched to the environment in order thus to increase visibility and safety. It would be conceivable here that light intensity and/or color are/is matched to the environment or light conditions or traffic conditions.

In the context of the present disclosure, it is optionally possible that the first print region and the second print region are configured such that transparent regions are provided for measurement by optical sensors.

The transparent regions are preferably suitable for sensors. Accordingly, the sensors, especially optical sensors, for example radar, lidar or cameras, may be disposed behind the injection-molded component.

A further aspect of the present disclosure is a process for producing an injection-molded component for a motor vehicle, especially an above-described injection-molded component. This process comprises the steps of:
printing a first foil insert with a first print region,
printing a second foil insert with a second print region,
providing an injection mold,
positioning the first foil insert in the injection mold,
positioning the second foil insert in the injection mold,
injecting a polymer material into the injection mold,
cooling the injection mold,
removing the injection-molded component from the injection mold.

The process makes it possible to rapidly, easily and cost-efficiently produce an injection-molded component for a motor vehicle with an optical effect that simultaneously increases safety.

The printing of the first or second print region can be produced by screen printing or digital printing.

In addition, it may be the case in the context of the present disclosure that at least one centering pin of the injection mold accepts at least one acceptor in the first foil insert and/or at least one acceptor in the second foil insert in the respective positioning operation.

This simplifies the positioning of the first and second foil inserts and ensures that positioning can be conducted more accurately. It is conceivable here that multiple centering pins are provided in order to position the first and second foil inserts. It is particularly advantageous here when the first and second foil inserts are positioned with the same centering pin. The acceptors corresponding to the centering pin in the first and second foil inserts are preferably configured such that they can be penetrated by the centering pins. For fixing of the first and second foil inserts, the centering pins may have grooves to accommodate the foil inserts.

In relation to the present disclosure, it is conceivable that at least three centering pins are provided, where each of the centering pins is assigned an acceptor in the first foil insert and an acceptor in the second foil insert.

The use of at least three centering pins allows better fixing of the position during the injection-molding operation. As mentioned, it is conceivable that even more centering pins are used. The number of centering pins is dependent on the size of the injection-molded component.

In the context of the present disclosure, it may be advantageous that the injection mold has a cavity, where the cavity is filled with a coating material to coat a surface of the first foil insert assigned to the environment.

The cavity corresponds to the thickness of the coating. For this purpose, it is possible to use the same material or a different kind of material. The coating serves as protection of the injection-molded component from environmental influences.

In the context of the present disclosure, it is conceivable that the injection-molded component is subjected to heat treatment in an additional step at a temperature between 100° C. and 140° C., preferably between 110° C. and 130° C., further preferably between 115° C. and 125° C..

Heat treatment of the component reduces intrinsic stresses on the injection-molded component, meaning that the heat treatment increases the lifetime of the injection-molded component.

It may be the case in the context of the present disclosure that the first foil insert and/or the second foil insert are/is preformed prior to positioning, where the preforming is established by thermoforming or high-pressure forming.

Preforming is useful when the injection-molded component has a curvature. The preforming thus allows the foil insert to be matched to a shape of the injection-molded component to be injection-molded.

The above object is also achieved by a motor vehicle of the present disclosure comprising an above-described injection-molded component.

Further features, advantages and details of the present disclosure will be apparent from the description that follows, in which multiple working examples of the present disclosure are described individually with reference to the drawings. The features mentioned in the claims and the description may each be essential to the present disclosure individually on their own or in any combination.

### BRIEF DESCRIPTION OF THE DRAWINGS

FIG. 1 is a schematic diagram of a section view through an injection-molded component.

FIG. 2 is a schematic diagram of the method/process for producing an injection-molded component.

### DETAILED DESCRIPTION OF THE DRAWINGS

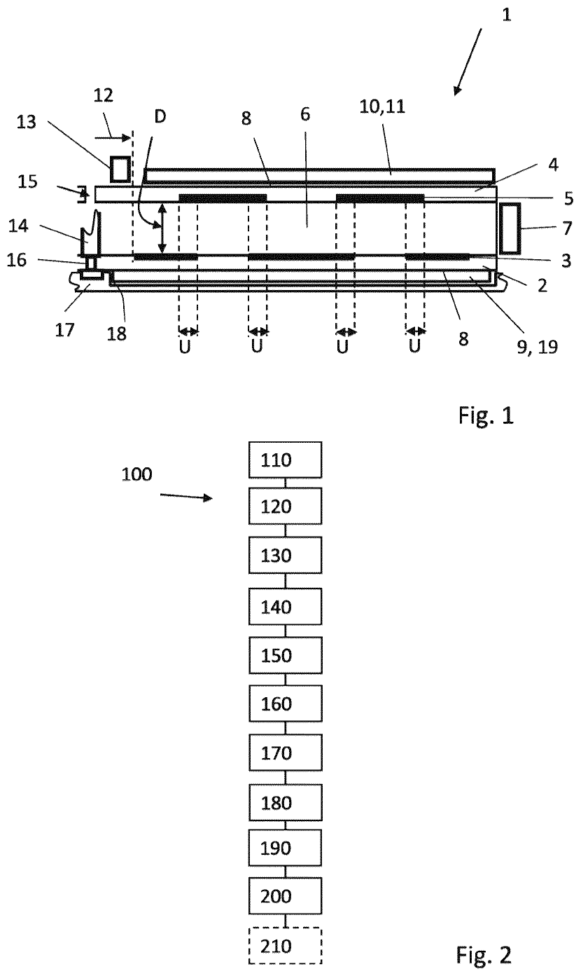

Elements having the same function and effect are given the same reference numerals in FIGS. 1 and 2.

FIG. 1 is a schematic diagram of an injection-molded component 1 for a motor vehicle. The injection-molded component 1 has a first foil insert 2 having a first print region 3, a second foil insert 4 having a second print region 5, and a transparent polymer layer 6 disposed between the first foil insert 2 and the second foil insert 4, wherein the first print region 3 is configured as a panel for coverage U of sections of the second print region 5.

The polymer layer 6 has a thickness D of 3 to 7 mm and is made from polycarbonate.

In addition, a light source 7 is provided for coupling of light into the polymer layer 6, where the light source 7 runs partly around the circumference of the injection-molded component 1 and, according to FIG. 1, is disposed laterally on the polymer layer 6.

For protection from environmental influences, the first foil insert 2 has a coating 9 on a surface facing away from the polymer layer 6.

In addition, the second foil insert 4 has an optical surface 8, in the present case a display 11, on a surface facing away from the polymer layer.

In addition, the first print region 3 and the second print region 5 are configured such that transparent regions 12 are provided for measurement by optical sensors 13.

FIG. 2 shows the method/process 100 for producing an above-described injection-molded component 1, wherein the process 100 comprises the steps of:
printing 110 a first foil insert 2 with a first print region,
printing 120 a second foil insert 4 with a second print region,
providing 130 an injection mold 17,
positioning 140 the first foil insert 2 in the injection mold 17,
positioning 150 the second foil insert 4 in the injection mold 17,
injecting 160 a polymer material into the injection mold 17,
cooling 170 the injection mold 17,
removing the injection-molded component 1 from the injection mold 17.

For positioning, at least one centering pin 14 in the injection mold 17 accepts at least one acceptor in the first foil insert 2 and at least one acceptor in the second foil insert 4. For this purpose, the centering pin 14 has a groove in each case.

For an injection-molded component 1, which is not shown completely, at least three centering pins 14 are provided. Each of these centering pins 14 is assigned an acceptor in the first foil insert 2 and an acceptor in the second foil insert 4.

For coating 190 of the surface 8 of the first foil insert 2 that faces away from the polymer layer, the injection mold 17 has a cavity filled with a coating material 19.

It is optionally possible for the injection-molded component 1 to be subjected to heat treatment 200 in an additional step at a temperature between 100° C. and 140° C. in order to dissipate residual stress.

In the case of a large, curved injection-molded component 1, the first foil insert 2 and the second foil insert 4 may optionally be preformed prior to positioning, where the preforming 210 is established by thermoforming or high-pressure forming.

### LIST OF REFERENCE NUMERALS

1 injection-molded component
2 first foil insert
3 first print region
4 second foil insert
5 second print region
6 polymer layer
7 light source
8 surface
9 coating
10 third foil insert, optical surface
11 display
12 regions
13 sensors
14 centering pin
15 acceptor
16 groove
17 injection mold
18 cavity
19 coating material
U coverage
D thickness
100 process
110 printing of a first foil insert
120 printing of a second foil insert
130 providing
140 positioning of the first foil insert
150 positioning of the second foil insert
160 injection
170 cooling
180 removing
190 coating
200 heat treatment
210 preforming

1.-14. (canceled)

15. An injection-molded component for a motor vehicle, comprising:
a first foil insert comprising a first print region;
a second foil insert comprising a second print region; and
a transparent polymer layer disposed between the first foil insert and the second foil insert,
wherein the first print region is configured as a panel for coverage of sections of the second print region.

16. The injection-molded component according to claim 15, wherein
the polymer layer has a thickness of 3 to 7 mm, preferably 4.5 to 6.5 mm, further preferably 5 to 6 mm.

17. The injection-molded component according to claim 15, wherein
the polymer layer is made from polymethyl-methacrylate (PMMA) and/or polycarbonate (PC).

18. The injection-molded component according to claim 15, further comprising:
a light source configured for coupling of light into the polymer layer, wherein the light source is configured to run at least partly around a circumference of the injection-molded component.

19. The injection-molded component according to claim 15, wherein
the first foil insert has a surface that faces away from the polymer layer, and wherein the surface has a coating.

20. The injection-molded component according to claim 15, wherein
the second foil insert, on a surface that faces away from the polymer layer, has a third foil insert or an optical surface, especially a display.

21. The injection-molded component according to claim 15, wherein
the first print region and the second print region are configured such that transparent regions are provided for measurement by optical sensors.

22. A method of producing an injection-molded component, wherein the injection-molded component comprises a first foil insert comprising a first print region; a second foil insert comprising a second print region; and a transparent polymer layer disposed between the first foil insert and the second foil insert, wherein the first print region is configured as a panel for coverage of sections of the second print region, the method comprising:
printing the first foil insert with the first print region;
printing the second foil insert with the second print region;
providing an injection mold;
positioning the first foil insert in the injection mold;
positioning the second foil insert in the injection mold;
injecting a polymer material into the injection mold;
cooling the injection mold; and
removing the injection-molded component from the injection mold.

23. The method according to claim 22,
further comprising accepting, by at least one centering pin of the injection mold, at least one acceptor in the first foil insert and/or at least one acceptor in the second foil insert in a respective positioning operation.

24. The method according to claim 23, further comprising:
providing at least three centering pins, wherein each of the centering pins is assigned an acceptor of the first foil insert and an acceptor of the second foil insert.

25. The method according to claim 22,
wherein the injection mold has a cavity, and the method further comprising filling the cavity with a coating material for coating a surface of the first foil insert which is assigned to an environment.

26. The method according to claim 22, further comprising subjecting the injection-molded component to heat treatment at a temperature between 100° C. and 140° C., preferably between 110° C. and 130° C., further preferably between 115° C. and 125° C.

27. The method according to claim 22, further comprising preforming
the first foil insert and/or the second foil insert prior to positioning, wherein the preforming is established by thermoforming or high-pressure forming.

28. A motor vehicle comprising an injection-molded component according to claim 15.
